(19) United States
(12) Patent Application Publication
(10) Pub. No.: US 2025/0233807 A1
(43) Pub. Date: Jul. 17, 2025

(54) ELECTRONIC DEVICE AND CONTROL METHOD THEREOF

(71) Applicant: Samsung Electronics Co., Ltd., Suwon-si (KR)

(72) Inventor: Kwanho PARK, Suwon-si (KR)

(21) Appl. No.: 19/169,533

(22) Filed: Apr. 3, 2025

Related U.S. Application Data
(63) Continuation of application No. PCT/KR2023/015674, filed on Oct. 12, 2023.

(30) Foreign Application Priority Data
Nov. 11, 2022 (KR) 10-2022-0150509

(51) Int. Cl. H04L 41/22

(52) U.S. Cl. CPC H04L 41/22

(57) ABSTRACT

An electronic device is provided. The electronic device includes a communication interface, memory storing one or more computer programs and control information corresponding to each of a plurality of external devices, and one or more processors communicatively coupled to the communication interface and the memory, wherein the one or more computer programs include computer-executable instructions that, when executed by the one or more processors individually or collectively, cause the electronic device to identify, based on receiving a control signal from a remote control device through the communication interface, whether the electronic device is in a control mode for controlling a first external device among the plurality of external devices, identify, based on identifying that the electronic device is in the control mode for controlling the first external device, first control information corresponding to the first external device based on the information stored in the memory and the received control signal, and transmit the identified first control information to at least one of a server or the first external device through the communication interface.

### CROSS-REFERENCE TO RELATED APPLICATION(S)

This application is a continuation application, claiming priority under 35 U.S.C. § 365 (c), of an International application No. PCT/KR2023/015674, filed on Oct. 12, 2023, which is based on and claims the benefit of a Korean patent application number 10-2022-0150509, filed on Nov. 11, 2022, in the Korean Intellectual Property Office, the disclosure of which is incorporated by reference herein in its entirety.

### BACKGROUND

### 1. Field

The disclosure relates to an electronic device and a control method thereof. More particularly, the disclosure relates to an electronic device that controls an external device in consideration of an operation mode of the electronic device, and a control method thereof.

### 2. Description of Related Art

Spurred by the development of electronic technologies, various types of electronic devices are being developed and distributed. In particular, recently, development of Internet of Things (IoT) technologies by which a plurality of devices are connected to a network, and exchange data is actively going on. Through data exchange among a plurality of IoT devices existing in a home, a user can be provided with services of good quality.

Meanwhile, a user needs to prepare a remote control device corresponding to a device, for controlling the device. A device is generally controlled through a unique signal that is promised between a remote control device and a device corresponding thereto, and accordingly, there is inconvenience for a user to have to prepare remote control devices corresponding to each device for controlling a plurality of devices.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device that controls an external device in consideration of an operation mode of the electronic device, and a control method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, memory storing one or more computer programs and control information corresponding to each of a plurality of external devices, and one or more processor s communicatively coupled to the communication interface and the memory, wherein the one or more computer programs include computer-executable instructions that, when executed by the one or more processors individually or collectively, cause the electronic device to identify, based on receiving a control signal from a remote control device through the communication interface, whether the electronic device is in a control mode for controlling a first external device among the plurality of external devices, identify, based on identifying that the electronic device is in the control mode for controlling the first external device, first control information corresponding to the first external device based on the information stored in the memory and the received control signal, and transmit the identified first control information to at least one of a server or the first external device through the communication interface.

In accordance with another aspect of the disclosure, a control method performed by an electronic device is provided. The control method includes, identifying, based on receiving a control signal from a remote control device, whether the electronic device is in a control mode for controlling a first external device among a plurality of external devices, identifying, based on identifying that the electronic device is in the control mode for controlling the first external device, first control information corresponding to the first external device based on control information corresponding to each of the plurality of external devices stored in memory and the received control signal, and transmitting the identified first control information to at least one of a server or the first external device.

In accordance with another aspect of the disclosure, one or more non-transitory computer-readable storage media storing one or more computer programs including computer-executable instructions that, when executed by one or more processors of an electronic device individually or collectively, cause an electronic device to perform operations is provided. The operations include, identifying, based on receiving a control signal from a remote control device, whether the electronic device is in a control mode for controlling a first external device among a plurality of external devices, identifying, based on identifying that the electronic device is in the control mode for controlling the first external device, first control information corresponding to the first external device based on control information corresponding to each of the plurality of external devices stored in memory and the received control signal, and transmitting the identified first control information to at least one of a server or the first external device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for schematically illustrating a control method of an electronic device according to an embodiment of the disclosure;

FIG. 2 is a block diagram illustrating a configuration of an electronic device according to an embodiment of the disclosure;

FIG. 3 is a flow chart for illustrating a control method of an electronic device according to an embodiment of the disclosure;

FIGS. 4A and 4B are diagrams for illustrating a method of operating in a control mode according to various embodiments of the disclosure;

FIG. 5 is a diagram for illustrating control information corresponding to each of a plurality of external devices according to an embodiment of the disclosure;

FIG. 6 is a diagram for illustrating a method of providing a guide user interface (UI) that recommends a control mode based on environment information according to an embodiment of the disclosure;

FIGS. 7A and 7B are sequence diagrams for illustrating an operation of a communication system according to various embodiments of the disclosure;

FIGS. 8A and 8B are sequence diagrams for illustrating an operation of a communication system according to various embodiments of the disclosure;

FIGS. 9A and 9B are sequence diagrams for illustrating an operation of a communication system according to various embodiments of the disclosure; and

FIG. 10 is a block diagram illustrating a detailed configuration of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

First, the terms used in this specification will be described briefly, and then the disclosure will be described in detail.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

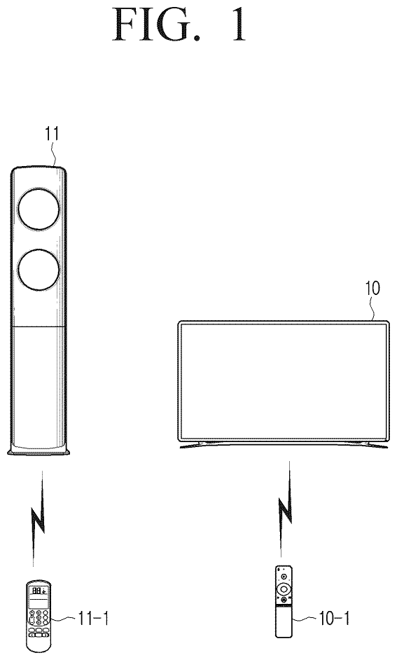

FIG. 1 is a diagram for schematically illustrating a control method of a conventional electronic device according to an embodiment of the disclosure.

Referring to FIG. 1, according to an embodiment, an electronic device 10 may receive a control signal from a remote control device 10-1 for controlling the electronic device 10, and perform an operation based on the received control signal. According to an embodiment, if a control signal corresponding to ‘volume up’ is received from the remote control device 10-1, the electronic device 10 may perform an operation corresponding to ‘volume up’ based on the received control signal.

Meanwhile, according to an embodiment, an external device 11 may receive a control signal from a remote control device 11-1 for controlling the external device 11, and perform an operation based on the received control signal. In this case, the external device 11 cannot identify a signal received from the remote control device 10-1 for controlling the electronic device 10 as a control signal, and for controlling the external device 11, the remote control device 11-1 for controlling the external device 11 is needed. That is, there is inconvenience for the user to have to prepare a plurality of remote control devices 10-1 and 11-1 for controlling each of a plurality of electronic devices, in order to control the plurality of electronic devices 10 and 11.

Accordingly, a UI for controlling an external device through a display provided on the electronic device 10 may be provided, but in this case, there is inconvenience that the user has to directly input an instruction desired by the user through the UI.

Hereinafter, various embodiments wherein, in case a user input was received through a remote control device, an external device is controlled in consideration of the operation mode of the electronic device, and a plurality of devices can be controlled just with a simple operation through a single remote control device will be explained.

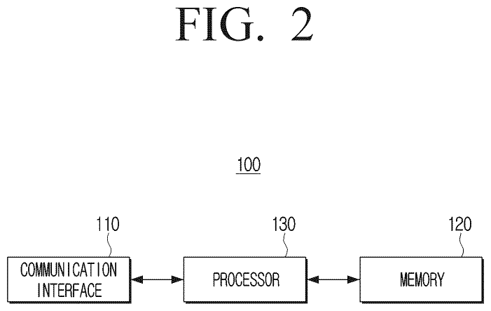

FIG. 2 is a block diagram illustrating a configuration of an electronic device according to an embodiment of the disclosure.

Referring to FIG. 2, the electronic device 100 may include a communication interface 110, memory 120, and one or more processors 130.

The electronic device 100 may be implemented as, for example, various devices that include a display and can reproduce image contents such as a smart television (TV), a tablet, a monitor, a smartphone, a desktop computer, a laptop computer, etc. However, the electronic device 100 according to an embodiment of the disclosure is not limited to the aforementioned devices, and the electronic device 100 may be implemented as an electronic device 100 equipped with two or more functions of the aforementioned devices.

Meanwhile, the electronic device 100 may be communicatively connected with an external device and an external server by various methods. According to an embodiment, communication modules for communication with an external device and an external server may be implemented to be the same. For example, the electronic device 100 may communicate with an external device by using a Bluetooth module, and may also communicate with an external server by using a Bluetooth module.

According to another embodiment, communication modules for communication with an external device and an external server may be implemented as separate modules. For example, the electronic device 100 may communicate with an external device by using a Bluetooth module, and may communicate with an external server by using an Ethernet modem or a Wi-Fi module.

The communication interface 110 may input and output various types of data. For example, the communication interface 110 may transmit and receive various types of data with an external device (e.g., a source device), an external storage medium (e.g., a USB memory), and an external server (e.g., a webhard) through communication methods such as AP-based Wi-Fi (Wi-Fi, a wireless local area network (LAN) network), Bluetooth, Zigbee, a wired/wireless local area network (LAN), a wide area network (WAN), an Ethernet, the Institute of Electrical and Electronics Engineers (IEEE) 1394, a high-definition multimedia interface (HDMI), a universal serial bus (USB), a mobile high-definition link (MHL), the Audio Engineering Society/European Broadcasting Union (AES/EBU), Optical, Coaxial, etc.

According to an embodiment, the communication interface 110 may include a Bluetooth Low Energy (BLE) module. BLE means a Bluetooth technology which enables transmission and reception of data of small capacity at low power in a 2.4 GHz frequency band having a reaching radius of about 10 m. However, the disclosure is not limited thereto, and the communication interface 110 may include a Wi-Fi communication module. That is, the communication interface 110 may include at least one of a Bluetooth Low Energy (BLE) module or a Wi-Fi communication module.

According to an embodiment, the communication interface 110 may use different communication modules for communicating with an external device such as a remote control device and an external server. For example, the communication interface 110 may use at least one of an Ethernet module or a Wi-Fi module for communicating with an external server, or use a Bluetooth module for communicating with an external device such as a remote control device. However, this is merely an embodiment, and the communication interface 110 may use at least one communication module among various communication modules in the case of communicating with a plurality of external devices or an external server.

The memory 120 may store data necessary for various embodiments. The memory 120 may be implemented in a form of memory embedded in the electronic device 100, or implemented in a form of memory that can be attached to or detached from the electronic device 100 according to the usage of stored data. For example, in the case of data for operating the electronic device 100, the data may be stored in memory embedded in the electronic device 100, and in the case of data for an extended function of the electronic device 100, the data may be stored in memory that can be attached to or detached from the electronic device 100.

Meanwhile, in the case of memory embedded in the electronic device 100, the memory may be implemented as at least one of volatile memory (e.g.: dynamic random access memory (DRAM), static random access memory (SRAM), or synchronous dynamic random access memory (SDRAM), etc.) or non-volatile memory (e.g.: one time programmable read only memory (OTPROM), programmable read only memory (PROM), erasable and programmable read only memory (EPROM), electrically erasable and programmable read only memory (EEPROM), mask read only memory (ROM), flash ROM, flash memory (e.g.: not and (NAND) flash or not or (NOR) flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

Meanwhile, according to an embodiment, in the memory 120, control information corresponding to each of a plurality of external devices may be stored. According to an embodiment, the plurality of external devices may be Internet of Things (IoT) devices in different types such as an air conditioner, a speaker, a projector, an air purifier, a fan, a refrigerator, a robot, etc. According to an embodiment, each of the plurality of external devices may be communicatively connected with a cloud server (not shown), and transmit and receive data through the cloud server (not shown). However, the disclosure is not limited thereto, and the plurality of external devices can obviously be communicatively connected among the external devices not via the cloud server (not shown), and transmit and receive data. That is, the plurality of external devices are not limited to IoT devices, and they may be electronic devices in different types that can be communicatively connected with the electronic device 100 and transmit and receive data.

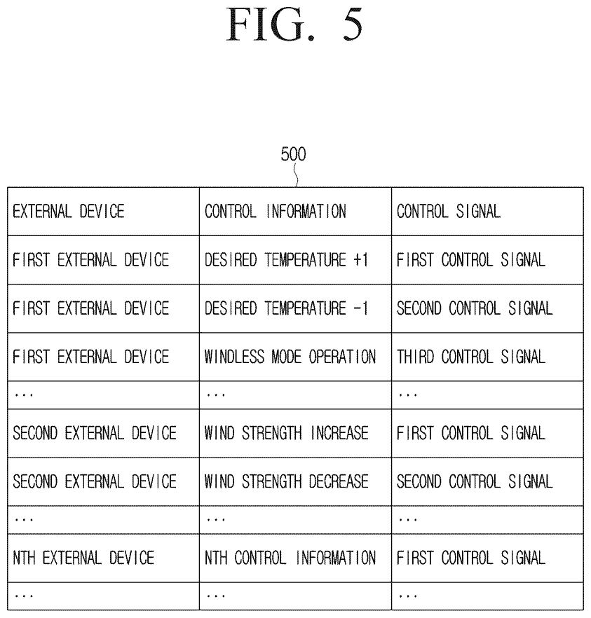

The control information corresponding to each of the plurality of external devices means information for the external devices to perform a specific operation (or, a specific function). According to an embodiment, the control information corresponding to each of the plurality of external devices may include control information mapped to each of a plurality of control signals received from a remote control device for each of the plurality of external devices. For example, in the memory 120, control information for functions of external devices mapped to each of a plurality of control signals received from a remote control device may be included. Detailed explanation in this regard will be described through FIG. 5.

The one or more processor s130 (referred to as a processor hereinafter) is electrically connected with the communication interface 110 and the memory 120, and controls the overall operations of the electronic device 100. The processor 130 may consist of one or a plurality of processors. Specifically, the processor 130 may perform the operations of the electronic device 100 according to the various embodiments of the disclosure by executing the at least one instruction stored in the memory 120.

According to an embodiment, the processor 130 may be implemented as a digital signal processor (DSP) processing digital image signals, a microprocessor, a graphics processing unit (GPU), an artificial intelligence (AI) processor, a neural processing unit (NPU), and a time controller (TCON). However, the disclosure is not limited thereto, and the processor 130 may include one or more of a central processing unit (CPU), a micro controller unit (MCU), a micro processing unit (MPU), a controller, an application processor (AP) or a communication processor (CP), and an ARM processor, or may be defined by the terms. Also, the processor 130 may be implemented as a system on chip (SoC) having a processing algorithm stored therein or large scale integration (LSI), or implemented in the form of an application specific integrated circuit (ASIC) or a field programmable gate array (FPGA).

According to an embodiment, the processor 130 may be implemented as a digital signal processor (DSP), a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP) or a communication processor (CP), and an ARM processor, or may be defined by the terms. Also, the processor 130 may be implemented as a system on chip (SoC) having a processing algorithm stored therein or large scale integration (LSI), or implemented in the form of a field programmable gate array (FPGA).

According to an embodiment, the processor 130 may receive a control signal from the remote control device through the communication interface 110.

According to an embodiment, the remote control device may be a control device for controlling the electronic device 100. That is, a control signal transmitted from the remote control device may be a control signal of a type that can be identified in an electronic device of the same type as the electronic device 100. According to an embodiment, in case the electronic device 100 is implemented as a TV, the remote control device may be a device that outputs a control signal for controlling the electronic device of the TV type. Meanwhile, according to an embodiment, a plurality of control signals of different types may be received. For example, in case the electronic device 100 is implemented as a TV, the type of a received control signal may be a control signal corresponding to ‘power off,’ ‘volume up,’ and ‘volume down,’ but is not limited thereto.

According to an embodiment, a control signal received from the remote control device may be any one of an infrared signal type, a Bluetooth Low Energy (BLE) signal type, or a wireless-fidelity (Wi-Fi) signal type. For example, the remote control device may modulate a signal corresponding to a user input, and output a control signal of the infrared signal type, and the processor 130 may receive the control signal of the infrared signal type from the remote control device through the communication interface 110.

Meanwhile, BLE means a Bluetooth technology which enables transmission and reception of data of small capacity at low power in a 2.4 GHz frequency band having a reaching radius of about 10m. According to an embodiment, the processor 130 may receive a control signal of the BLE type through the communication interface 110. Alternatively, the processor 130 may receive a control signal of the Wi-Fi signal type from the remote control device through the communication interface 110 including a Wi-Fi module.

Meanwhile, according to an embodiment, if a control signal is received from the remote control device through the communication interface 110, the processor 130 may identify whether the electronic device 100 is in a control mode for controlling an external device. Here, the control mode means a mode set in the electronic device 100 for controlling any one of the plurality of external devices based on a received control signal. For example, the electronic device 100 may be in the control mode for controlling a first external device among the plurality of external devices.

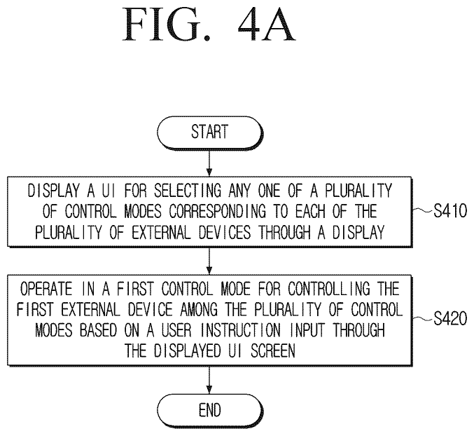

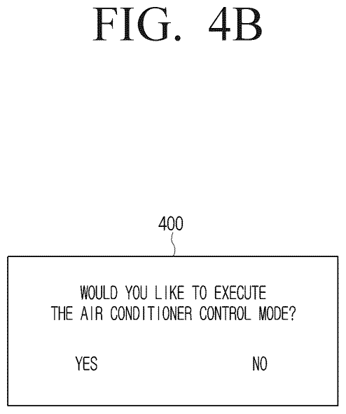

According to an embodiment, in the memory 120, data necessary for operating in control modes corresponding to each of the plurality of external devices may be stored, and the processor 130 may identify any one of the plurality of control modes based on a user input, etc., and operate in any one control mode identified based on the information stored in the memory 120. Detailed explanation in this regard will be described through FIGS. 4A and 4B.

According to an embodiment, the processor 130 may identify control information corresponding to an external device based on the information stored in the memory 120 and a received control signal.

According to an embodiment, if it is identified that the electronic device 100 is in the control mode for controlling the first external device, the processor 130 may identify first control information corresponding to the first external device based on the information stored in the memory 120 and a received control signal. For example, in the memory 120, control information mapped to each of a plurality of control signals received from the remote control device may be stored for each of the plurality of external devices. In case it was identified that the electronic device 100 is in the control mode for controlling the first external device among the plurality of external devices, the processor 130 may identify the first control information corresponding to the received control signal among the plurality of control information corresponding to the first external device among the information stored in the memory 120. That is, the identified first control information may be control information for performing the function of the first external device.

According to an embodiment, the processor 130 may transmit the identified first control information to at least one of a server or the first external device through the communication interface 110. Here, the server may be a cloud server according to an embodiment. According to an embodiment, the processor 130 may transmit the identified first control information to the server (not shown). In this case, the server (not shown) that received the first control information may transmit the information to the first external device.

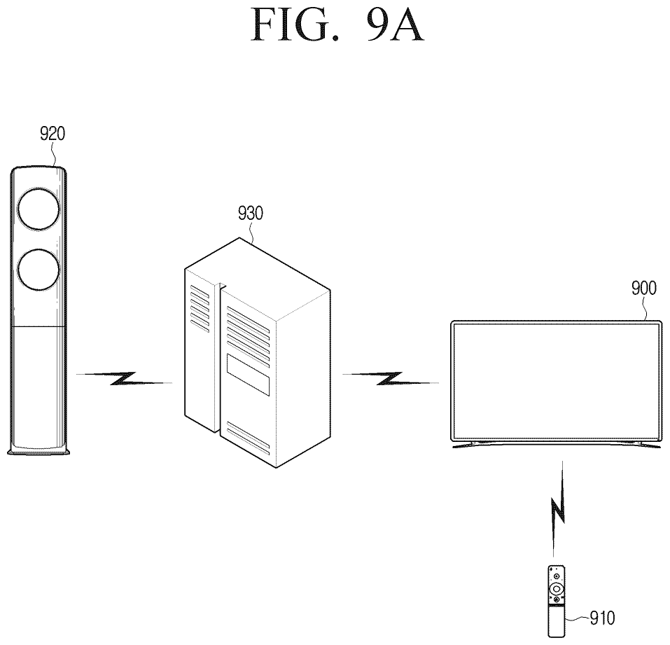

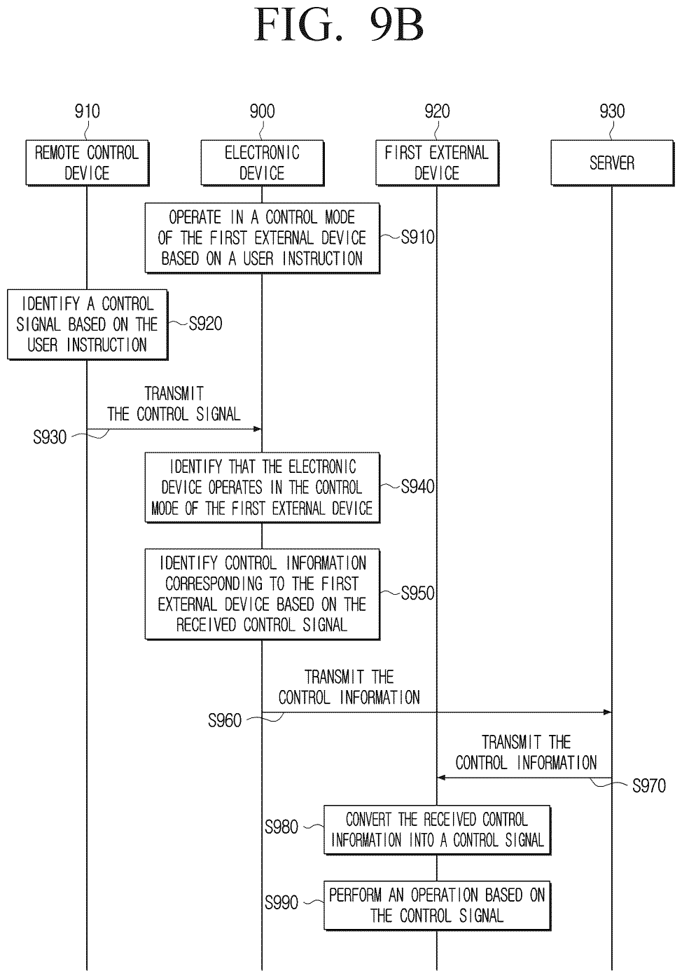

Meanwhile, according to an embodiment, the processor 130 may transmit the identified first control information and information on the external device which becomes the subject of the identified first control information to the server. For example, the processor 130 may transmit the identified first control information and information indicating that the subject to be controlled is the first external device. When the identified first control information and the information indicating that the subject to be controlled is the first external device are received, the server may transmit the information to the first external device. Detailed explanation in this regard will be described through FIGS. 9A and 9B.

Alternatively, according to an embodiment, the processor 130 may transmit the identified first control information to the first external device, and the first external device may convert the identified first control information and obtain a control signal corresponding to the first control information, and perform an operation corresponding to the first control information based on the obtained control signal.

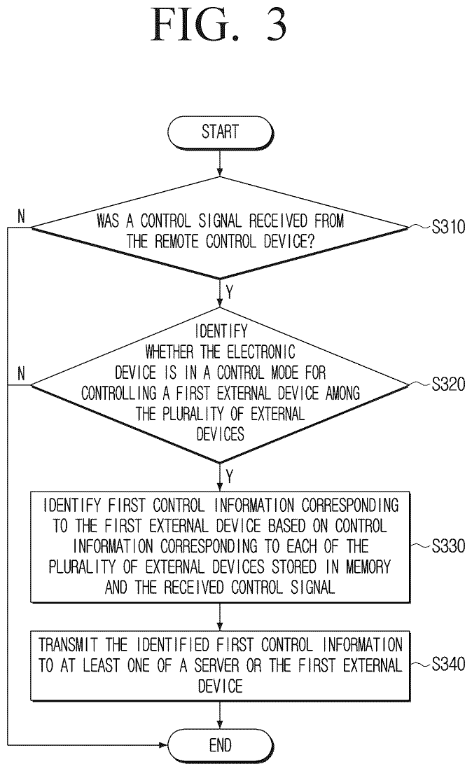

FIG. 3 is a flow chart for illustrating a control method of an electronic device according to an embodiment of the disclosure.

Referring to FIG. 3, first, according to an embodiment, in the control method, it may be identified whether a control signal is received from the remote control device in operation S310. According to an embodiment, in case the electronic device 100 is implemented as a TV, the processor 130 may receive a first control signal corresponding to ‘volume up’ among a plurality of control signals from the remote control device through the communication interface 110.

Then, according to an embodiment, in the control method, if a control signal is received from the remote control device (Y), it may be identified whether the electronic device 100 is in a control mode for controlling a first external device among the plurality of external devices in operation S320.

According to an embodiment, when the first control signal is received from the remote control device through the communication interface 110, the processor 130 may identify whether the electronic device 100 operates in a control mode for controlling an external device. For example, in case the electronic device 100 operates in a control mode for controlling an air conditioner among the plurality of external devices, the processor 130 may identify that the electronic device 100 is in the control mode for controlling the air conditioner among the plurality of external devices.

Then, according to an embodiment, in the control method, if it is identified that the electronic device 100 is in the control mode for controlling the first external device among the plurality of external devices, first control information corresponding to the first external device may be identified based on the control information corresponding to each of the plurality of external devices stored in the memory 120 and the received control signal in operation S330.

According to an embodiment, if it is identified that the electronic device 100 is in the control mode for controlling the air conditioner among the plurality of external devices, control information corresponding to the air conditioner may be identified based on the control information corresponding to the air conditioner stored in the memory 120 and the received first control signal. For example, the processor 130 may identify ‘a desired temperature +1’ which is control information corresponding to the received first control signal among the plurality of control information corresponding to the air conditioner stored in the memory 120.

Then, according to an embodiment, in the control method, the identified first control information may be transmitted to at least one of the server or the first external device in operation S340.

According to an embodiment, if ‘a desired temperature +1’ which is control information corresponding to the received first control signal among the plurality of control information corresponding to the air conditioner is identified, the processor 130 may transmit the identified first control information to the cloud server (not shown) through the communication interface 110. When the identified first control information is received at the cloud server (not shown), the cloud server may transmit the first control information to the air conditioner among the plurality of external devices, and the air conditioner that received the first control information may convert ‘a desired temperature +1’ which is the identified control information and identify a corresponding control signal, and perform a corresponding operation based on this.

Alternatively, according to an embodiment, if ‘a desired temperature +1’ which is control information corresponding to the received first control signal among the plurality of control information corresponding to the air conditioner is identified, the processor 130 may transmit the identified first control information to the air conditioner through the communication interface 110. The air conditioner that received the first control information may convert ‘a desired temperature +1’ which is the identified control information and identify a corresponding control signal, and perform a corresponding operation based on this.

According to the aforementioned example, in the case of receiving a control signal corresponding to the electronic device 100, the electronic device 100 may identify control information for any one of the plurality of external devices in consideration of the operation mode of the electronic device 100, and the external device may perform an operation corresponding to a user instruction based on the identified control information. That is, the user can control a plurality of devices just with a simple operation through a single remote control device. Accordingly, the user's convenience is increased.

FIGS. 4A and 4B are diagrams for illustrating a method of operating in a control mode according to various embodiments of the disclosure.

According to an embodiment, the electronic device 100 may further include a display (not shown). The processor 130 may operate in a control mode for controlling an external device based on a user input received through a UI displayed through the display (not shown).

Referring to FIG. 4A, according to an embodiment, in the control method, a UI for selecting any one of the plurality of control modes corresponding to each of the plurality of external devices may be displayed through the display (not shown) in operation S410.

Referring to FIG. 4B, the electronic device 100 may be implemented as a display device including a display (not shown). The processor 130 may display a UI for selecting a control mode corresponding to the air conditioner among the control modes corresponding to each of the plurality of external devices. For example, the UI may include a prompt 400 ‘Would you like to execute the air conditioner control mode?’ and information for receiving a user input corresponding thereto.

However, the disclosure is not limited thereto, and according to an embodiment, the processor 130 may provide a UI for selecting any one of the plurality of external devices. For example, the UI may be implemented as a guide UI including ‘Please select a control mode’ and information for selecting any one of the plurality of external devices.

Then, according to an embodiment, in the control method, the processor 130 may operate in the first control mode for controlling the first external device among the plurality of control modes based on a user instruction that was input through the displayed UI screen in operation S420.

According to an embodiment, if a user instruction selecting the control mode corresponding to the air conditioner is input through the UI screen for selecting the control mode corresponding to the air conditioner among the control modes corresponding to each of the plurality of external devices displayed through the display (not shown), the processor 130 may operate in the first control mode for controlling the air conditioner among the plurality of control modes based on this.

Alternatively, according to an embodiment, if a user instruction selecting the control mode corresponding to the air conditioner is input through the UI screen for selecting any one of the control modes for the plurality of external devices, the processor 130 may operate in the first control mode for controlling the air conditioner among the plurality of control modes based on this.

According to the aforementioned example, the electronic device 100 may operate in a control mode corresponding to any one external device among the plurality of external devices based on a user input, and identify a control signal corresponding to any one of the plurality of external devices based on this.

FIG. 5 is a diagram for illustrating control information corresponding to each of a plurality of external devices according to an embodiment of the disclosure.

Referring to FIG. 5, according to an embodiment, in the memory 120, control information corresponding to each of the plurality of external devices may be stored.

According to an embodiment, the control information corresponding to each of the plurality of external devices may include control information mapped to each of a plurality of control signals received from the remote control device for each of the plurality of external devices. For example, in the memory 120, a plurality of control information corresponding to the first external device may be stored, and to each of the plurality of control information corresponding to the first external device, a plurality of control signals received from the remote control device may respectively be mapped.

Meanwhile, according to an embodiment, the control information stored in the memory 120 may include control information for functions of an external device mapped to each of a plurality of control signals received from the remote control device. For example, in the memory 120, a table 500 including a plurality of control information corresponding to each of a plurality of functions of the air conditioner (e.g., ‘a desired temperature +1,’ ‘a desired temperature −1,’ and ‘a windless mode operation’) among the plurality of external devices may be stored.

According to an embodiment, if a control signal is received while the electronic device 100 operates in a control mode for controlling an external device, the processor 130 may identify control information based on the information stored in the memory 120.

According to an embodiment, if a control signal is received from the remote control device while operating in the first control mode for controlling the first external device among the plurality of control modes corresponding to each of the plurality of external devices, the processor 130 may identify the first control information mapped to the received control signal based on the information corresponding to the first external device among the information stored in the memory 120.

For example, if a first control signal corresponding to ‘TV volume up’ is received from the remote control device through the communication interface 110 while the electronic device 100 operates in the control mode for controlling the air conditioner which is the first external device, the processor 130 may identify ‘a desired temperature +1’ which is the control information corresponding to the first control signal among the plurality of control information corresponding to the first external device based on the information stored in the memory 120.

Alternatively, for example, if the first control signal corresponding to ‘TV volume up’ is received from the remote control device through the communication interface 110 while the electronic device 100 operates in the control mode for controlling the air purifier which is the second external device, the processor 130 may identify ‘wind strength +1’ which is the control information corresponding to the first control signal among the plurality of control information corresponding to the air purifier which is the second external device based on the information stored in the memory 120. However, the disclosure is not limited thereto, and types of control information corresponding to a control signal can obviously be different.

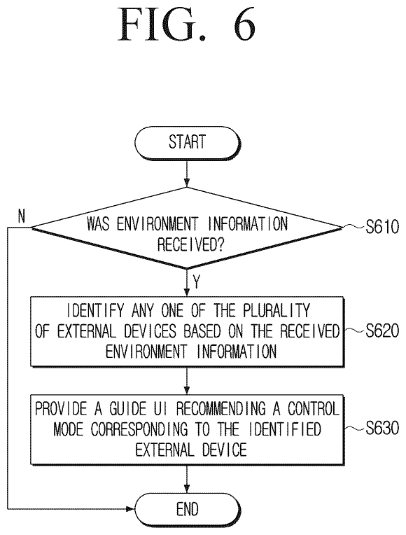

FIG. 6 is a diagram for illustrating a method of providing a guide UI that recommends a control mode based on environment information according to an embodiment of the disclosure.

According to an embodiment, the processor 130 may identify any one external device based on environment information, and provide a guide UI recommending a control mode corresponding to the identified external device.

Referring to FIG. 6, according to an embodiment, first, the processor 130 may identify whether environment information is received in operation S610. Here, according to an embodiment, the environment information may be information on the temperature, the humidity, the fine dust concentration, and the illumination around the electronic device 100 or the plurality of external devices, but is not limited thereto, and the environment information may include different types of information for the environment around the electronic device 100 or the plurality of external devices. For example, the processor 130 may receive information on the current temperature and time of the refrigerator which is any one of the plurality of external devices. Alternatively, the processor 130 may receive information on the temperature around the air conditioner or the temperature in the home from the air conditioner which is any one of the plurality of external devices. Alternatively, the processor 130 may receive information on the fine dust concentration from the air purifier.

However, the disclosure is not limited thereto, and according to an embodiment, the electronic device 100 may identify environment information. For example, the electronic device 100 may include at least one sensor, and the processor 130 can obviously identify at least one of the information on the temperature, the humidity, the fine dust concentration, and the illumination around the electronic device 100 through the at least one sensor.

Alternatively, according to an embodiment, the processor 130 can obviously receive environment information from the cloud server (not shown) through the communication interface 110.

Then, according to an embodiment, in the control method, if environment information is received (Y), any one of the plurality of external devices may be identified based on the received environment information in operation S620.

According to an embodiment, in case temperature information in the home was received through the communication interface 110, the processor 130 may identify whether the temperature in the home is greater than or equal to a predetermined value. If the temperature in the home is identified to be greater than or equal to the predetermined value, the processor 130 may identify the air conditioner among the plurality of external devices based on the information stored in the memory 120.

Meanwhile, according to an embodiment, in the memory 120, information on external devices mapped to each of a plurality of types of environment information may be stored. According to an embodiment, an external device corresponding to the temperature information stored in the memory 120 may be the air conditioner or the air purifier. Alternatively, according to an embodiment, an external device corresponding to the fine dust concentration may be the air conditioner or the air purifier. The processor 130 may identify any one of the plurality of external devices based on the information stored in the memory 120 and the received environment information.

Then, according to an embodiment, in the control method, a guide UI recommending a control mode corresponding to the identified external device may be provided in operation S630. According to an embodiment, in case any one external device was identified based on the received environment information, the processor 130 may provide a guide UI recommending a control mode corresponding to the identified external device.

For example, if the temperature in the home is identified to be greater than or equal to the predetermined value through the previously received temperature information, the processor 130 may identify the air conditioner among the plurality of external devices based on this. Then, the processor 130 may display a guide UI recommending a control mode corresponding to the identified external device through the display (not shown). In this case, according to an embodiment, the guide UI may include ‘Would you like to execute the air conditioner control mode?’ and information for receiving a user input corresponding thereto. However, the disclosure is not limited thereto, and a guide UI including a different text from the aforementioned UI can obviously be displayed.

Returning to FIG. 2, according to an embodiment, the processor 130 may transmit the control information identified through the communication interface 110 to at least one of the server or an external device.

According to an embodiment, a case wherein the electronic device 100 operates in the control mode for controlling the first external device is assumed. According to an embodiment, the plurality of external devices may be implemented as IoT devices that are communicatively connected with the cloud server (not shown), and if the first control information for controlling the first external device among the plurality of external devices is identified based on a received control signal, the processor 130 may transmit the identified first control information to the cloud server (not shown) through the communication interface 110. In this case, the identified first control information may be converted into a control signal for controlling the operation of the first external device at the cloud server (not shown), and may be provided to the first external device.

However, the disclosure is not limited thereto, and according to an embodiment, the identified first control information may be converted into a control signal for controlling the operation of the first external device at the first external device. For example, if the first control information is received from the cloud server (not shown) to the first external device, the first control information may be converted into a control signal for controlling the operation of the first external device at the first external device. That is, the identified control information may be converted at any one of the cloud server (not shown) or an external device. However, the disclosure is not limited thereto, and a signal converted from control information at the electronic device 100 can obviously be transmitted to the server or an external device. Detailed explanation in this regard will be described through FIGS. 9A and 9B.

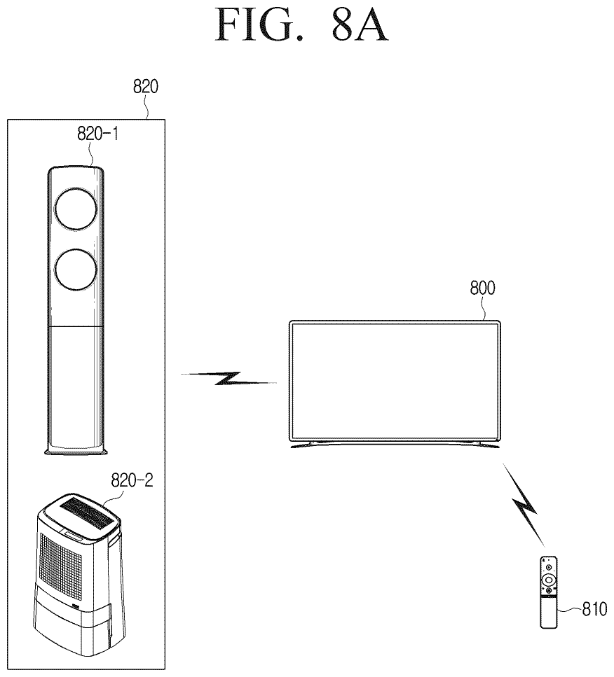

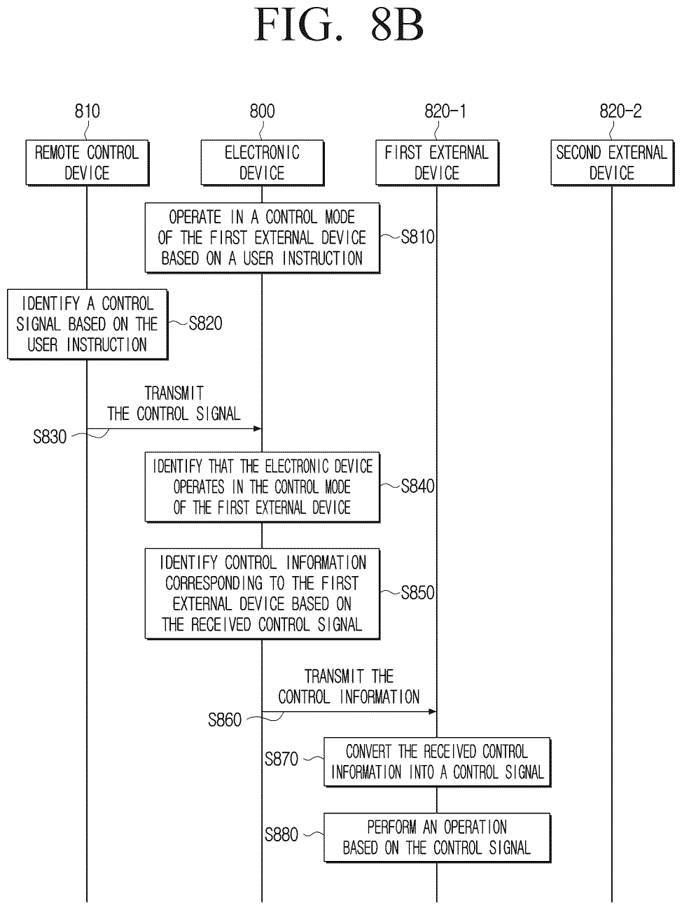

Meanwhile, according to an embodiment, the processor 130 may transmit the identified first control information to the first external device through the communication interface 110. In this case, according to an embodiment, the identified first control information may be converted into a control signal for controlling the operation of the first external device at the first external device. However, the disclosure is not limited thereto, and according to an embodiment, a signal converted from control information at the electronic device 100 can obviously be transmitted to the server or an external device. Detailed explanation in this regard will be described through FIGS. 8A and 8B.

Meanwhile, according to an embodiment, if it is identified that the electronic device 100 is not in a control mode for controlling the plurality of external devices, the processor 130 may control the operation of the electronic device 100 based on a received control signal. According to an embodiment, a case wherein a control signal corresponding to ‘volume up’ is received from the remote control device is assumed. If it is identified that the electronic device 100 is not in a control mode for controlling an external device, the processor 130 may perform an operation corresponding to ‘volume up’ based on a received control signal corresponding to ‘volume up.’

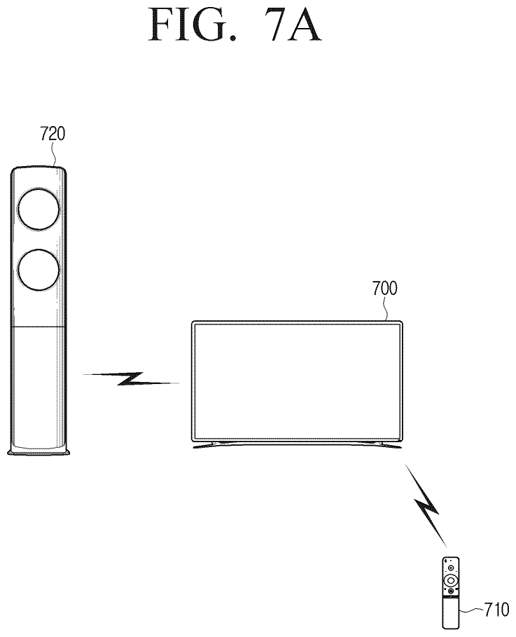

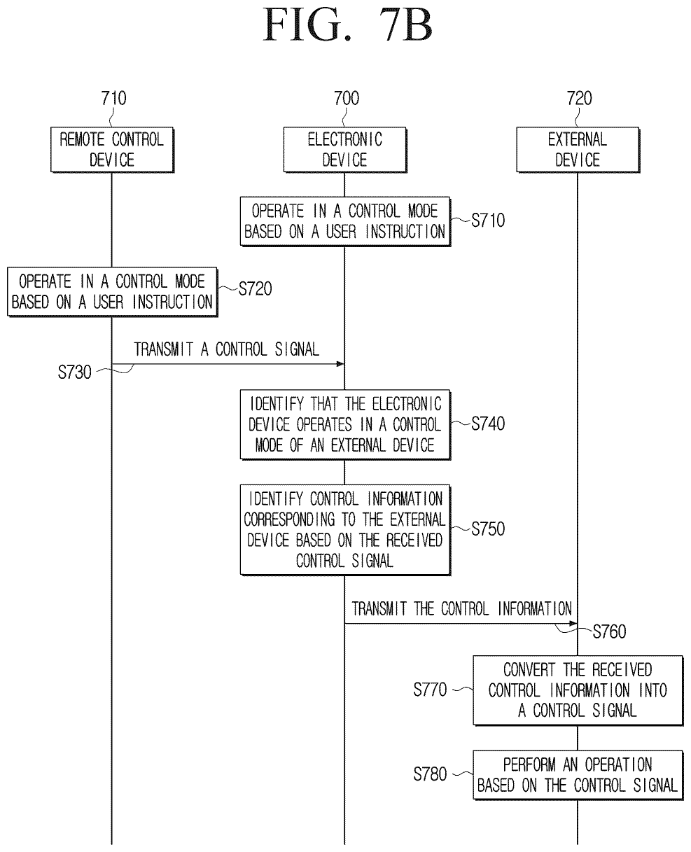

FIGS. 7A and 7B are sequence diagrams for illustrating an operation of a communication system according to various embodiments of the disclosure.

Referring to FIG. 7A, according to an embodiment, the electronic device 700 may be communicatively connected with a remote control device 710 and an external device 720, and transmit and receive data.

Referring to FIGS. 7A and 7B, first, according to an embodiment, the electronic device 700 may operate in a control mode for controlling an external device based on a user instruction in operation S710. According to an embodiment, the electronic device 700 may operate in a control mode for controlling the air conditioner among the plurality of external devices 720 that are communicatively connected with the electronic device 700 based on the received user instruction.

Meanwhile, according to an embodiment, the remote control device 710 may identify a control signal based on the user instruction in operation S720. According to an embodiment, the remote control device 710 may be a control device for controlling the electronic device 700. When a user instruction is received, the remote control device 710 may identify a control signal corresponding to the received user instruction. For example, when a user instruction corresponding to ‘volume up’ is received, the remote control device 710 may identify a control signal corresponding to the received ‘volume up.’

According to an embodiment, if a control signal is identified, the remote control device 710 may transmit the identified control signal to the electronic device 700 in operation S730. Also, according to an embodiment, the remote control device 710 may transmit the identified control signal corresponding to ‘volume up’ to the electronic device 700 through the communication interface.

Then, according to an embodiment, the electronic device 700 may identify that the electronic device 700 operates in a control mode of the external device 720 in operation S740. According to an embodiment, if a control signal corresponding to ‘volume up’ is received from the remote control device 710, the electronic device 700 may identify whether the electronic device 700 operates in the control mode of the external device 720.

Then, according to an embodiment, if it is identified that the electronic device 700 operates in the control mode for controlling the external device 720, the electronic device 700 may identify control information corresponding to the external device 720 based on the received control signal in operation S750. According to an embodiment, if a control signal corresponding to ‘volume up’ is received through the communication interface, the electronic device 700 may identify ‘a desired temperature +1’ which is control information mapped to the received control signal corresponding to ‘volume up’ among the plurality of control information corresponding to the external device 720 based on the information stored in the memory.

Then, according to an embodiment, the electronic device 700 may transmit the identified control information to the external device 720 in operation S760. According to an embodiment, the electronic device 700 may transmit the identified control information corresponding to ‘a desired temperature +1’ to the external device 720 through the communication interface.

Then, according to an embodiment, the external device 720 may convert the received control information into a control signal in operation S770. According to an embodiment, if the control information corresponding to ‘a desired temperature +1’ is received from the electronic device 700, the external device 720 may obtain a control signal corresponding to the received control information by using a predetermined algorithm. Alternatively, the external device 720 may obtain a control signal corresponding to the control information received from the electronic device 700 based on the information stored in the memory.

Then, according to an embodiment, the external device 720 may perform an operation based on the control signal in operation S780. According to an embodiment, if the control information corresponding to ‘a desired temperature +1’ is converted into a control signal, the external device 720 may perform an operation corresponding to ‘a desired temperature +1’ based on the converted control signal.

According to the aforementioned example, in case the electronic device 700 operates in the control mode for controlling the external device 720, the user can control the external device 720 by using the remote control device 710 for controlling the electronic device 700. Accordingly, the user can simply control the external device 720 by using the electronic device 700 without a separate remote control device 710 for controlling the external device 720.

FIGS. 8A and 8B are sequence diagrams for illustrating an operation of a communication system according to various embodiments of the disclosure.

Referring to FIG. 8A, according to an embodiment, the electronic device 800 may be communicatively connected with the remote control device 810, the first external device 820-1, and the second external device 820-2, and transmit and receive data. However, the disclosure is not limited thereto, and according to an embodiment, the electronic device 800 may be communicatively connected with a plurality of external devices including the first external device 820-1 and the second external device 820-2, and transmit and receive data.

Referring to FIG. 8B, first, according to an embodiment, the electronic device 800 may operate in a control mode for controlling the first external device based on a user instruction in operation S810. According to an embodiment, the electronic device 800 may operate in a control mode for controlling the air conditioner corresponding to the first external device 820-1 among the plurality of external devices 820 that are communicatively connected with the electronic device 800 based on the received user instruction.

Meanwhile, according to an embodiment, the remote control device 810 may identify a control signal based on the user instruction in operation S820. According to an embodiment, the remote control device 810 may be a control device for controlling the electronic device 800. When a user instruction is received, the remote control device 810 may identify a control signal corresponding to the received user instruction. For example, if a user instruction corresponding to ‘volume down’ is received, the remote control device 810 may identify a control signal corresponding to the received ‘volume down.’

According to an embodiment, when the control signal is identified, the remote control device 810 may transmit the identified control signal to the electronic device 800 in operation S830. According to an embodiment, the remote control device 810 may transmit the identified control signal corresponding to ‘volume down’ to the electronic device 800 through the communication interface.

Then, according to an embodiment, the electronic device 800 may identify that the electronic device 800 operates in the control mode of the first external device 820-1 among the plurality of external devices in operation S840. According to an embodiment, when the control signal corresponding to ‘volume down’ is received from the remote control device 810, the electronic device 800 may identify whether the electronic device 800 operates in the control mode of the air conditioner corresponding to the first external device 820-1 among the plurality of external devices 820.

Then, according to an embodiment, if it is identified that the electronic device 800 operates in the control mode for controlling the first external device 820-1, the electronic device 800 may identify control information corresponding to the first external device 820-1 based on the received control signal in operation S850. According to an embodiment, when the control signal corresponding to ‘volume down’ is received through the communication interface, the electronic device 800 may identify ‘a desired temperature −1’ which is the control information mapped to the received control signal corresponding to ‘volume down’ among the plurality of control information corresponding to the first external device 820-1 based on the information stored in the memory.

Then, according to an embodiment, the electronic device 800 may transmit the identified control information to the first external device 820-1 in operation S860. According to an embodiment, the electronic device 800 may transmit the identified control information corresponding to ‘a desired temperature −1’ to the first external device 820-1 through the communication interface.

Then, according to an embodiment, the first external device 820-1 may convert the received control information into a control signal in operation S870. According to an embodiment, when the control information corresponding to ‘a desired temperature −1’ is received from the electronic device 800, the first external device 820-1 may obtain a control signal corresponding to the received control information by using the predetermined algorithm. Alternatively, the first external device 820-1 may obtain a control signal corresponding to the control information received from the electronic device 800 based on the information stored in the memory.

Then, according to an embodiment, the first external device 820-1 may perform an operation based on the control signal in operation S880. According to an embodiment, when the control information corresponding to ‘a desired temperature −1’ is converted into a control signal, the first external device 820-1 may perform an operation corresponding to ‘a desired temperature −1’ based on the converted control signal.

FIGS. 9A and 9B are sequence diagrams for illustrating an operation of a communication system according to various embodiments of the disclosure.

Referring to FIGS. 9A and 9B, according to an embodiment, the electronic device 900 may be communicatively connected with the remote control device 910 and the server 930, and transmit and receive data. According to an embodiment, the electronic device 900 and the first external device 920 may be implemented as IoT devices, and the server 930 may be implemented as a cloud server. According to an embodiment, the electronic device 900 and the first external device 920 may transmit and receive data through the server 930.

First, according to an embodiment, the electronic device 900 may operate in a control mode for controlling an external device based on a user instruction in operation S910. According to an embodiment, the electronic device 900 may operate in a control mode for controlling the air conditioner which is the first external device 920 among the plurality of external devices 920 that are communicatively connected with the electronic device 900 based on the received user instruction.

Meanwhile, according to an embodiment, the remote control device 910 may identify a control signal based on the user instruction in operation S920. According to an embodiment, the remote control device 910 may be a control device for controlling the electronic device 900. When a user instruction is received, the remote control device 910 may identify a control signal corresponding to the received user instruction. For example, if a user instruction corresponding to ‘menu selection’ is received, the remote control device 910 may identify a control signal corresponding to the received ‘menu selection.’

According to an embodiment, when the control signal is identified, the remote control device 910 may transmit the identified control signal to the electronic device 900 in operation S930. According to an embodiment, the remote control device 910 may transmit the identified control signal corresponding to ‘menu selection’ to the electronic device 900 through the communication interface.

Then, according to an embodiment, the electronic device 900 may identify that the electronic device 900 operates in the control mode of the first external device 920 in operation S940. According to an embodiment, when the control signal corresponding to ‘menu selection’ is received from the remote control device 910, the electronic device 900 may identify whether the electronic device 900 operates in the control mode of the first external device 920.

Then, according to an embodiment, if it is identified that the electronic device 900 operates in the control mode for controlling the first external device 920, the electronic device 900 may identify control information corresponding to the first external device 920 based on the received control signal in operation S950. According to an embodiment, when the control signal corresponding to ‘menu selection’ is received through the communication interface, the electronic device 900 may identify ‘a windless mode operation’ which is the control information mapped to the received control signal corresponding to ‘menu selection’ among the plurality of control information corresponding to the first external device 920 based on the information stored in the memory. However, this is merely an example, and the control information corresponding to ‘menu selection’ can obviously be a different type of information from ‘a windless mode operation.’

Then, according to an embodiment, the electronic device 900 may transmit the identified control information to the server 930 in operation S960. According to an embodiment, the electronic device 900 may transmit the identified control information corresponding to ‘a windless mode operation’ to the server 930 through the communication interface.

In this case, according to an embodiment, the electronic device 900 may transmit the identified control information and information on the subject to be controlled to the server 930. For example, the electronic device 900 may transmit the identified control information corresponding to ‘a windless mode operation’ and information indicating that the subject to be controlled is the first external device 920 to the server 930 through the communication interface.

Then, according to an embodiment, the server 930 may transmit the identified control information to the first external device 920 in operation S970. According to an embodiment, the server 930 may receive the information indicating that the subject to be controlled is the first external device 920 together with the identified control information corresponding to ‘a windless mode operation’ from the electronic device 900, and the server 930 may transmit the identified control information corresponding to ‘a windless mode operation’ to the first external device 920 among the plurality of external devices through the communication interface based on this.

Then, according to an embodiment, the first external device 920 may convert the received control information into a control signal in operation S980. According to an embodiment, when the control information corresponding to ‘a windless mode operation’ is received from the electronic device 900, the first external device 920 may obtain a control signal corresponding to the received control information by using the predetermined algorithm. Alternatively, the first external device 920 may obtain a control signal corresponding to the control information received from the electronic device 900 based on the information stored in the memory.

However, the disclosure is not limited thereto, and according to an embodiment, the server 930 can obviously convert the control information into a control signal corresponding to the first external device 920, and transmit the control signal to the first external device 920. Alternatively, the electronic device 900 may convert the control information into a control signal corresponding to the first external device 920, and transmit the control signal converted from the control information to the server 930.

Then, according to an embodiment, the first external device 920 may perform an operation based on the control signal in operation S990. According to an embodiment, when the control information corresponding to ‘a windless mode operation’ is converted into a control signal, the first external device 920 may perform an operation corresponding to ‘a windless mode operation’ based on the converted control signal.

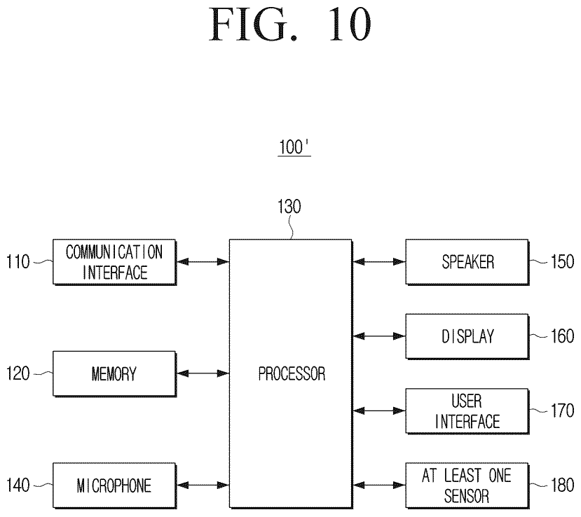

FIG. 10 is a block diagram illustrating a detailed configuration of an electronic device according to an embodiment of the disclosure.

Referring to FIG. 10, the electronic device 100′ may include a communication interface 110, memory 120, one or more processors 130, a microphone 140, a speaker 150, a display 160, a user interface 170, and at least one sensor 180. Among the components illustrated in FIG. 10, regarding components overlapping with the components illustrated in FIG. 2, detailed explanation will be omitted.

The microphone 140 may mean a module that obtains a sound and converts it into an electric signal, and it may be a condenser microphone, a ribbon microphone, a moving coil microphone, a piezoelectric element microphone, a carbon microphone, and a micro electro mechanical system (MEMS) microphone. Also, the microphone 140 may be implemented by methods such as a non-directional method, a bi-directional method, a uni-directional method, a sub cardioid method, a super cardioid method, and a hyper cardioid method.

There may be various embodiments wherein the electronic device 100′ performs an operation corresponding to a user voice signal received through the microphone 140.

As an example, the electronic device 100′ may control the display 160 based on a user voice signal received through the microphone 140. For example, if a user voice signal for displaying an A content is received, the electronic device 100′ may control the display 160 to display the A content.

As another example, the electronic device 100′ may control an external display device connected with the electronic device 100′ based on a user voice signal received through the microphone 140. Specifically, the electronic device 100′ may provide a control signal for controlling the external display device such that an operation corresponding to a user voice signal is performed in the external display device, and transmit the provided control signal to the external display device. Here, the electronic device 100′ may store a remote control application for controlling the external display device. Then, the electronic device 100′ may transmit the provided control signal to the external display device by using at least one communication method among Bluetooth, Wi-Fi, or infrared communication methods. For example, if a user voice signal for displaying the A content is received, the electronic device 100′ may transmit a control signal for controlling such that the A content is displayed on the external display device to the external display device. Here, the electronic device 100′ may mean various terminal devices wherein a remote control application can be installed such as a smartphone, an AI speaker, etc.

As still another example, the electronic device 100′ may use a remote control device for controlling an external display device connected with the electronic device 100′ based on a user voice signal received through the microphone 140. Specifically, the electronic device 100′ may transmit a control signal for controlling the external display device such that an operation corresponding to a user voice signal is performed in the external display device to the remote control device. Then, the remote control device may transmit the control signal received from the electronic device 100′ to the external display device. For example, if a user voice signal for displaying the A content is received, the electronic device 100′ may transmit a control signal for controlling such that the A content is displayed on the external display device to the remote control device, and the remote control device may transmit the received control signal to the external display device.

The speaker 150 may consist of a tweeter for reproducing sounds of high-pitched ranges, a mid-range for reproducing sounds of mid-pitched ranges, a woofer for reproducing sounds of low-pitched ranges, a sub-woofer for reproducing sounds of extreme low-pitched ranges, an enclosure for controlling resonances, and a crossover network dividing frequencies of electric signals input into the speaker by each band.

The speaker 150 may output an acoustic signal to the outside of the electronic device 100′. The speaker 150 may output reproduction of multimedia, reproduction of recording, various types of notification sounds, voice messages, etc. The electronic device 100′ may include an audio output device such as the speaker 150, but may also include an output device such as an audio output terminal. In particular, the speaker 150 may provide obtained information, information processed⋅produced based on the obtained information, a response result or an operation result for a user voice, etc. in voice forms.

The display 160 may be implemented as a display including self-emission elements, or a display including non-self-emission elements and a backlight. For example, the display 160 may be implemented as various forms of displays such as a liquid crystal display (LCD), an organic light emitting diodes (OLED) display, light emitting diodes (LEDs), micro LEDs, mini LEDs, a plasma display panel (PDP), a quantum dot (QD) display, quantum dot light emitting diodes (QLEDs), etc. Inside the display 160, driving circuits that may be implemented in forms such as an a-si thin film transistor (TFT), a low temperature poly silicon (LTPS) TFT, an organic TFT (OTFT), etc., and a backlight unit, etc. may also be included. Meanwhile, the display 160 may be implemented as a touch screen combined with a touch sensor, a flexible display, a rollable display, a three dimensional (3D) display, a display wherein a plurality of display modules are physically connected, etc. The processor 130 may control the display 160 to output an output image obtained according to the aforementioned various embodiments. Here, an output image may be a high resolution image of 4K or 8K or higher.

Meanwhile, according to another embodiment, the electronic device 100′ may not include a display 160. The electronic device 100′ may be connected with an external display device, and transmit an image or a content stored in the electronic device 100′ to the external display device. Specifically, the electronic device 100′ may transmit an image or a content together with a control signal for controlling such that the image or the content is displayed on an external display device to the external display device.

Here, the external display device may be connected with the electronic device 100′ through the communication interface 110 or an input/output interface (not shown). For example, the electronic device 100′ may not include a display like a set top box (STB). Also, the electronic device 100′ may include only a display of a small size that can display only simple information such as text information, etc. Here, the electronic device 100′ may transmit an image or a content to the external display device via wire or wirelessly through the communication interface 110, or transmit them to the external display device through the input/output interface (not shown).

The user interface 170 is a component for the electronic device 100′ to perform interaction with the user. For example, the user interface 170 may include at least one of a touch sensor, a motion sensor, buttons, a jog dial, a switch, a microphone, or a speaker, but is not limited thereto.

The at least one sensor 180 (referred to as the sensor hereinafter) may include a plurality of sensors of various types. The sensor 180 may measure a physical amount or detect an operation state of the electronic device 100′, and convert the measured or detected information into an electric signal. The sensor 180 may include a camera, and the camera may include a lens that focuses various visible optical signals that are reflected by an object and received into an image sensor, and an image sensor that can detect various visible optical signals. Here, the image sensor may include a two dimensional (2D) pixel array divided into a plurality of pixels.

According to the aforementioned example, in case the electronic device 100′ received a control signal for controlling the electronic device 100′, the electronic device 100′ can identify control information for any one of the plurality of external devices in consideration of the operation mode of the electronic device 100′, and the external device can perform an operation based on the identified control information. Accordingly, the user can control the external device by using a remote control device corresponding to the electronic device 100′, and thus the user's convenience is increased.

Meanwhile, the methods according to the aforementioned various embodiments of the disclosure may be implemented in forms of applications that can be installed on conventional electronic devices. Alternatively, the methods according to the aforementioned various embodiments of the disclosure may be performed by using a trained neural network based on deep learning (or a deeply trained neural network), i.e., a learning network model. Also, the methods according to the aforementioned various embodiments of the disclosure may be implemented just with software upgrade, or hardware upgrade of conventional electronic devices. Further, the aforementioned various embodiments of the disclosure may be performed through an embedded server provided on an electronic device, or an external server of an electronic device.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed on-line in the form of a storage medium that is readable by machines (e.g.: compact disc read only memory (CD-ROM)), or through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g. a module or a program) may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. A module, a program, or operations performed by other components according to the various embodiments may be executed sequentially, in parallel, repetitively, or heuristically. Or, at least some of the operations may be executed in a different order or omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication interface;
memory storing one or more computer programs and control information corresponding to each of a plurality of external devices; and
one or more processors communicatively coupled to the communication interface and the memory,
wherein the one or more computer programs include computer-executable instructions that, when executed by the one or more processors individually or collectively, cause the electronic device to:
identify, based on receiving a control signal from a remote control device through the communication interface, whether the electronic device is in a control mode for controlling a first external device among the plurality of external devices,
identify, based on identifying that the electronic device is in the control mode for controlling the first external device, first control information corresponding to the first external device based on the information stored in the memory and the received control signal, and
transmit the identified first control information to at least one of a server or the first external device through the communication interface.

2. The electronic device of claim 1, further comprising:
a display,
wherein the one or more computer programs include computer-executable instructions that, when executed by the one or more processors individually or collectively, cause the electronic device to:
control the display to display a user interface (UI) for selecting any one of a plurality of control modes corresponding to each of the plurality of external devices, and
operate in a first control mode for controlling the first external device among the plurality of control modes based on a user instruction input through the displayed UI screen.

3. The electronic device of claim 1,
wherein the control information corresponding to each of the plurality of external devices comprises:
controlling information mapped to each of a plurality of control signals received from the remote control device for each of the plurality of external devices, and
wherein the one or more computer programs include computer-executable instructions that, when executed by the one or more processors individually or collectively, cause the electronic device to:
based on receiving a control signal from the remote control device while operating in the first control mode for controlling the first external device among the plurality of control modes corresponding to each of the plurality of external devices, identify the first control information matched to the received control signal on the basis of information corresponding to the first external device among the information stored in the memory.

4. The electronic device of claim 1, wherein the one or more computer programs include computer-executable instructions that, when executed by the one or more processors individually or collectively, cause the electronic device to:
based on receiving environment information through the communication interface, identify any one of the plurality of external devices on the basis of the received environment information; and
provide a guide UI recommending a control mode corresponding to the identified external device.

5. The electronic device of claim 1,
wherein the plurality of external devices are implemented as internet of things (IoT) devices communicatively connected with the server,
wherein the one or more computer programs include computer-executable instructions that, when executed by the one or more processors individually or collectively, cause the electronic device to:
transmit the first control information to the server through the communication interface, and
wherein the first control information is converted into a control signal for controlling operations of the first external device at the server, and is provided to the first external device.

6. The electronic device of claim 1,
wherein the plurality of external devices are implemented as internet of things (IoT) devices communicatively connected with the server,
wherein the one or more computer programs include computer-executable instructions that, when executed by the one or more processors individually or collectively, cause the electronic device to:
transmit the identified first control information to the server, and
wherein the identified first control information is, based on the identified first control information being received at the first external device from the server, converted into a control signal for controlling operations of the first external device at the first external device.

7. The electronic device of claim 1,
wherein the one or more computer programs include computer-executable instructions that, when executed by the one or more processors individually or collectively, cause the electronic device to:
transmit the first control information to the first external device through the communication interface, and
wherein the first control information is converted into a control signal for controlling operations of the first external device at the first external device.

8. The electronic device of claim 1, wherein the one or more computer programs include computer-executable instructions that, when executed by the one or more processors individually or collectively, cause the electronic device to:
based on identifying that the electronic device is not in the control mode for controlling the plurality of external devices, control operations of the electronic device based on the received control signal.

9. The electronic device of claim 1,
wherein the first external device is implemented as an air conditioner, and
wherein the information stored in the memory includes control information for functions of the air conditioner mapped to each of a plurality of control signals received from the remote control device.

10. The electronic device of claim 1, wherein the control signal received from the remote control device is any one of an infrared signal type, a bluetooth low energy (BLE) signal type, or a wireless-fidelity (Wi-Fi) signal type.

11. A control method performed by an electronic device, the control method comprising:
based on receiving a control signal from a remote control device, identifying whether the electronic device is in a control mode for controlling a first external device among a plurality of external devices;
based on identifying that the electronic device is in the control mode for controlling the first external device, identifying first control information corresponding to the first external device based on control information corresponding to each of the plurality of external devices stored in memory and the received control signal; and
transmitting the identified first control information to at least one of a server or the first external device.

12. The control method of claim 11, further comprising:
displaying a user interface (UI) for selecting any one of a plurality of control modes corresponding to each of the plurality of external devices through a display; and
operating in a first control mode for controlling the first external device among the plurality of control modes based on a user instruction input through the displayed UI screen.

13. The control method of claim 11,
wherein the control information corresponding to each of the plurality of external devices comprises:
control information mapped to each of a plurality of control signals received from the remote control device for each of the plurality of external devices, and
wherein the identifying the control information comprises:
identifying, based on receiving a control signal from the remote control device while operating in the first control mode for controlling the first external device among the plurality of control modes corresponding to each of the plurality of external devices, the first control information matched to the received control signal on the basis of information corresponding to the first external device among the information stored in the memory.

14. The control method of claim 11, further comprising:
identifying, based on receiving environment information, any one of the plurality of external devices on the basis of the received environment information; and
providing a guide UI recommending a control mode corresponding to the identified external device.

15. The control method of claim 11,
wherein the plurality of external devices are implemented as internet of things (IoT) devices communicatively connected with the server,
wherein the transmitting comprises:
transmitting the identified first control information to the server, and
wherein the identified first control information is converted into a control signal for controlling operations of the first external device at the server, and is provided to the first external device.

16. The control method of claim 11, further comprising:
transmitting the first control information to the first external device through the communication interface,
wherein the first control information is converted into a control signal for controlling operations of the first external device at the first external device.

17. The control method of claim 11, further comprising:
controlling, based on identifying that the electronic device is not in the control mode for controlling the plurality of external devices, operations of the electronic device based on the received control signal.

18. The control method of claim 11, wherein the control signal received from the remote control device is any one of an infrared signal type, a bluetooth low energy (BLE) signal type, or a wireless-fidelity (Wi-Fi) signal type.

19. One or more non-transitory computer-readable storage media storing one or more computer programs including computer-executable instructions that, when executed by one or more processors of an electronic device individually or collectively, cause the electronic device to perform operations, the operations comprising:
identifying, based on receiving a control signal from a remote control device, whether the electronic device is in a control mode for controlling a first external device among a plurality of external devices;
identifying, based on identifying that the electronic device is in the control mode for controlling the first external device, first control information corresponding to the first external device based on control information corresponding to each of the plurality of external devices stored in memory and the received control signal; and
transmitting the identified first control information to at least one of a server or the first external device.

20. The one or more non-transitory computer-readable storage media of claim 19, the operations further comprising:
displaying a user interface (UI) for selecting any one of a plurality of control modes corresponding to each of the plurality of external devices through a display; and
operating in a first control mode for controlling the first external device among the plurality of control modes based on a user instruction input through the displayed UI screen.
